(19) United States
(12) Patent Application Publication
(10) Pub. No.: US 2022/0204205 A1
(43) Pub. Date: Jun. 30, 2022

(54) LINER-LESS LABEL PRE-FEED SYSTEM

(71) Applicant: Toshiba America Business Solutions, Inc., Lake Forest, CA (US)

(72) Inventors: William M. Connors, Lexington, KY (US); Donn D. Bryant, Lexington, KY (US); Michael W. Lawrence, Lexington, KY (US); George N. Woolcott, Lancaster, KY (US)

(21) Appl. No.: 17/552,053

(22) Filed: Dec. 15, 2021

Related U.S. Application Data
(60) Provisional application No. 63/125,543, filed on Dec. 15, 2020.
(60) Provisional application No. 63/239,944, filed on Sep. 2, 2021.

(51) Int. Cl. B65C 9/42; B65C 9/18; B41J 15/16; B41J 15/04

(52) U.S. Cl. CPC B65C 9/42; B41J 15/04; B41J 15/16; B65C 9/18

(57) ABSTRACT

A system and method for feeding a ribbon of un-lined label stock to a printer includes first and second, abutting rollers that cooperatively remove label stock from a roll. An optical sensor is disposed in a ribbon path between the rollers and the printer. The optical sensor determines a slackness level of the ribbon between rollers and the printer. Speed of a drive roller drive motor is increased when the slackness level is below a prescribed threshold. Speed of the drive roller motor is decreased when the slackness level is above a prescribed threshold.

### TECHNICAL FIELD OF THE INVENTION

This application relates generally to label printing. The application relates more particularly to in-line label printing on liner-less label stock.

### BACKGROUND OF THE INVENTION

Labels are affixed to packaging to display information, such as a destination address, return address, or product information. Early labels comprised a lined adhesive side and a printable surface side. After printing, the lining is removed and the adhesive surface is placed on the packaging. More recently, duplex printing, which is printing on both sides of a label is used. Duplex printing facilitates providing information, such item lists or return address labeling, on un-gummed or non-adhesive areas of an adhesive side of the label. The shipping label may be scored such that, when pulled away from a package, the un-gummed, printed portion is revealed. In-line printing involves use of label stock removed from a label roll. A series of labels are printed and cut sequentially.

Liner-Less label stock is a relatively new development in packaging and shipping. Labels can be comprised of a single sheet with a designated area on the front side for the shipping address. The back side of each label has an adhesive area around a periphery with a designated print zone in the middle for printing information such as shipping, customer invoice information or a return label. These labels can be retrieved from a roll or reel for printing. There is no release paper on the adhesive nor any plastic sleeve for the label. Waste is thus eliminated with this label.

### BRIEF DESCRIPTION OF THE DRAWINGS

Various embodiments will become better understood with regard to the following description, appended claims and accompanying drawings wherein:

FIG. 1 an example embodiment of an in-line printer for duplex printing on a ribbon of liner-less label stock from a roll;

FIG. 2 is another example embodiment of in-line printer for duplex printing on a ribbon of liner-less label stock removed from roll;

FIG. 3 is a schematic of an example embodiment of a liner-label system that includes a pre-feed control system operable by microcontroller; and

FIG. 4 is an example embodiment of a flowchart of a liner-less label pre-feed system operable in conjunction with a microcontroller.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

An example of in-line print of liner-less labels can be found in U.S. Pat. No. 8,109,537, entitled “Linerless Packing and Shipping Label System,” the contents of which are incorporated herein by reference.

Duplex printing on liner-less label stock suffers with issues relative to peeling labels off a roll on which they are shipped. Exposed adhesive can create relatively high and inconsistent forces with label feed mechanisms.

Example embodiments herein provide a liner-less label pre-feed system that efficiently peels the continuous form labels off the roll and then presents them to an in-line printer such that the force required to feed them into the printer is low and consistent. An independent feed nip system is provided with a high gear ratio that can handle torque needed to strip labels off a roll and then feed them at, or close to, the same rate as an in-line printer consumes them. A feedback system verifies that a correct queue of labels is in place in front of the In-Line Printer.

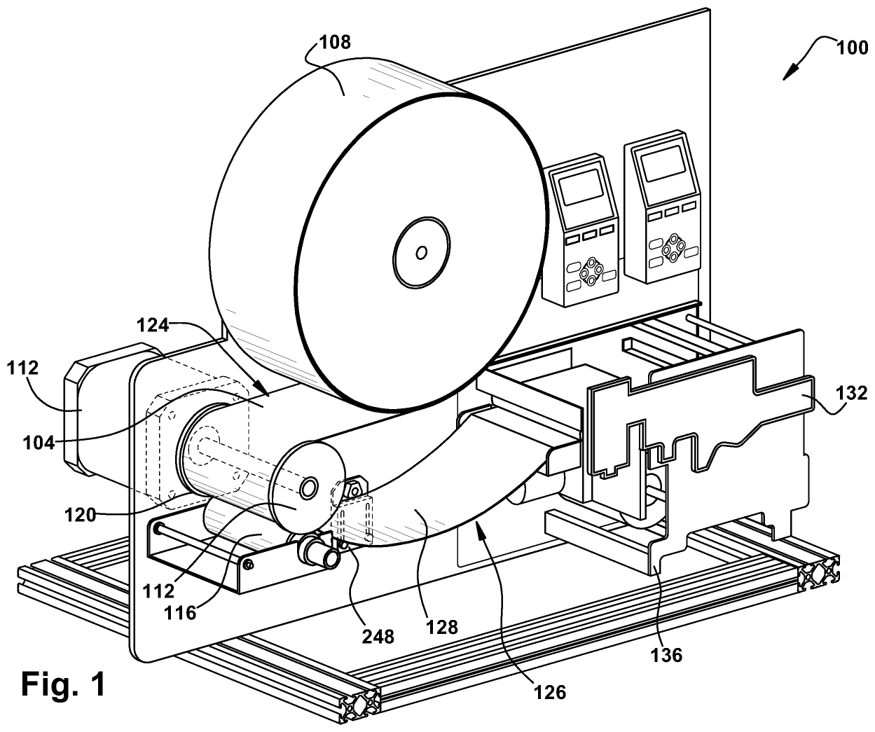

FIG. 1 illustrates an example embodiment of an in-line printer 100 for duplex printing on a ribbon of liner-less label stock 104 from roll 108. Label stock 104 is secured between a surface of powered drive roller 112 and a surface of counter-rotating idler roller 116, entering nip 120 there-between. Label stock 104 comprises a ribbon having a liner-less adhesive side 124 and a non-adhesive side 128. Label stock 104 is advanced to duplex printer 132 by contact of non-adhesive side 128 with a malleable surface of drive roller 112 and contact with adhesive side 124 with a malleable surface of idler roller 116. Both roller surfaces are suitably formed from rubber, or any other suitable gripping surface. In an example embodiment, the surface of idler roller 116 is comprised of silicone rubber to minimize adhesion to the adhesive side 124 of label stock 104. As will be detailed further below, duplex printer 132 includes rollers to further advance the label stock 104 for printing and cutting. Slack 136 is maintained in label stock 104 between rollers 112 and 116 and duplex printer 132 as described further below.

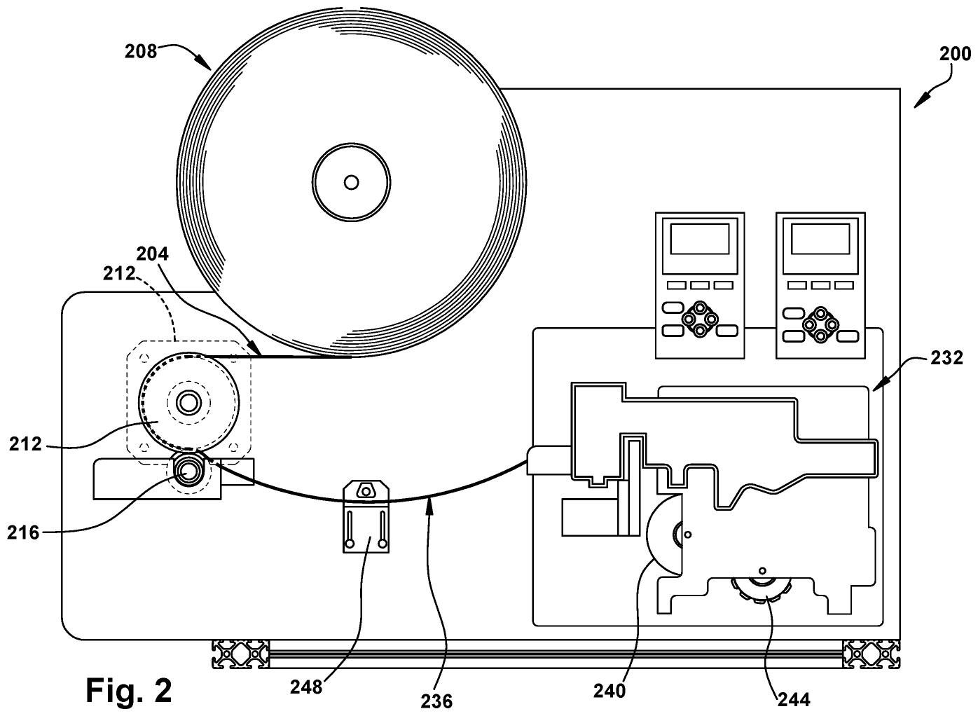

FIG. 2 illustrates an example embodiment of in-line printer 200 for duplex printing on a ribbon of liner-less label stock 204 removed from roll 208 cooperatively by drive roller 212 and idler roller 216. Printing is accomplished by duplex printer 232 on a feed of label stock 204 from a slackened portion 236. Duplex printer 232 includes printer drive rollers 240 and 244 to advance label stock through for printing and cutting. Slackened portion 236 is maintained by adjusting a rotational speed of drive roller 212 in accordance with feedback received from a non-contact sensor array comprised of optical sensor array 248. When a slack level is deemed to be greater than a preset threshold, rotation of drive roller 212 is slowed. When a slack level is deemed to less than a preset threshold, rotation of drive roller 212 is sped up. Rotational speed is suitably dictated by digital control of one or more stepper motors, such as stepper motor 252. Thus, slackness is maintained within a desired range.

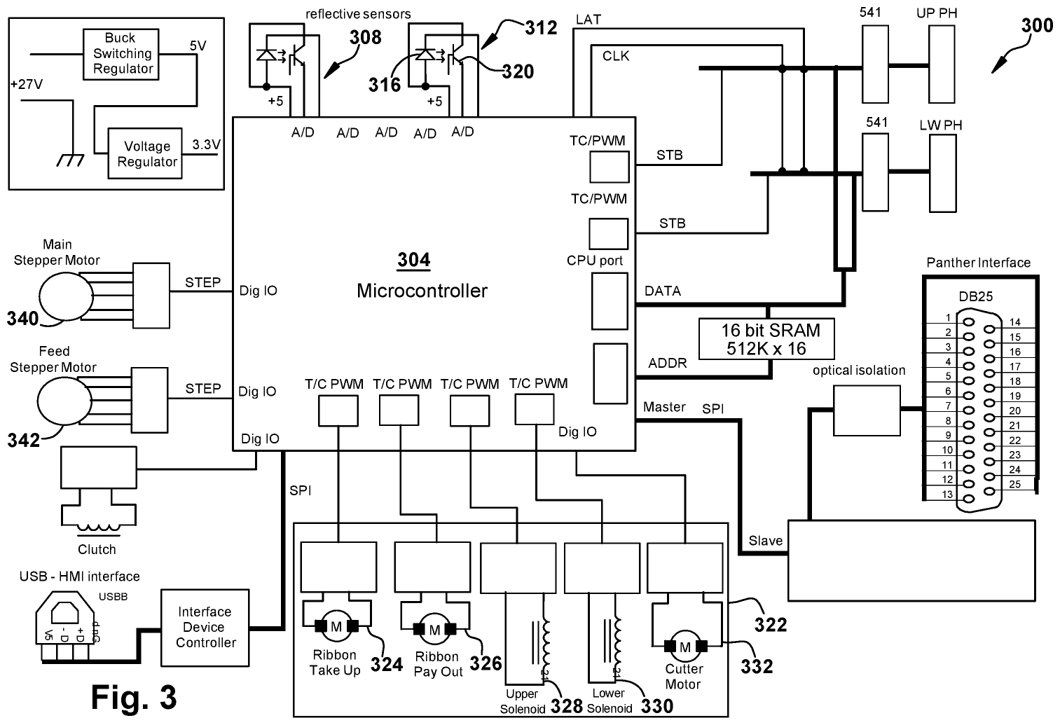

FIG. 3 is a schematic of an example embodiment of a liner-label system 300 that includes a pre-feed control system operable by microcontroller 304. Slackness of a label ribbon is determined in accordance with input received from an array of reflective sensors, illustrated by sensors 308 and 312. In the illustrated example, the reflective sensors are comprised of a light emitting diode (LED) and phototransistor pair, such as LED 316 and phototransistor 320 of sensor 312.

Block 322 illustrates components associated with a duplex, in-line printer, also suitably controlled by microcontroller 304. Included are motor/roller pairs 324 and 326 which function for ribbon take up and ribbon pay out, respectively. Solenoid 328 is operable to control an upper print head and solenoid 330 is operable to control a lower printhead for duplex, in-line printing. Cutter motor 332 is operable to cut individual labels from the ribbon. An interface to each of the motors and solenoids of block is suitably accomplished with an associated brush driver.

Also under control of microcontroller 304 are main stepper motor 340 and feed stepper motor 342. Feed stepper motor 342 accomplishes speeding or slowing of a feed roller under control of microcontroller 304. An interface to each of the stepper motors is suitably accomplished with an associated motor driver.

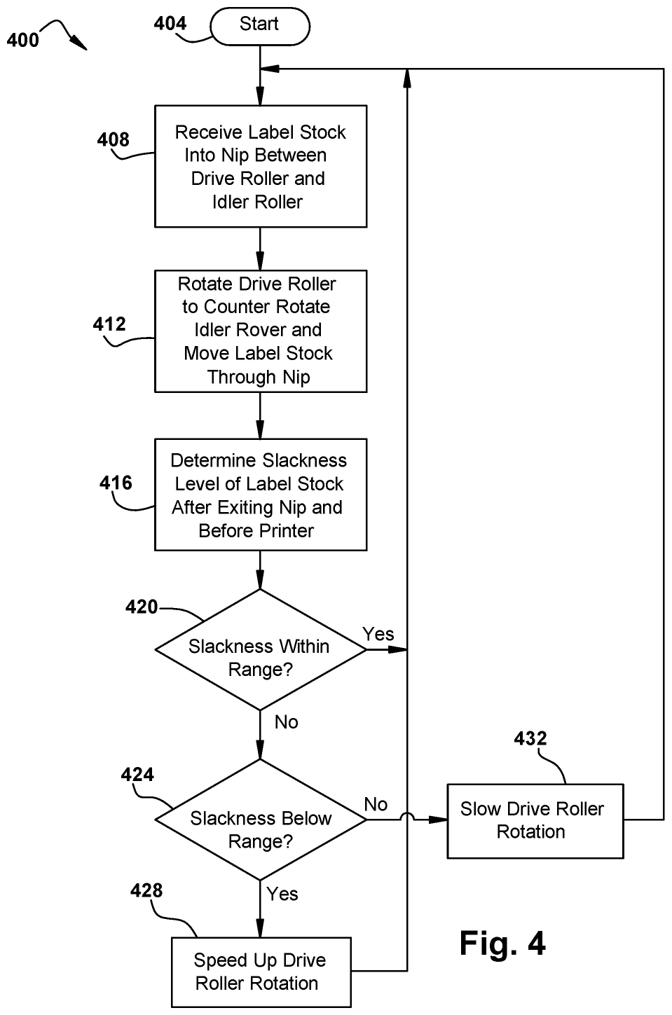

FIG. 4 is a flowchart 400 of a liner-less label pre-feed system, suitably operable in conjunction with microcontroller 304 of FIG. 2. The process commences a block 404 and proceeds to block 408 where a label stock from a spooled ribbon is received into a nip between a drive roller and associated idler roller. Both rollers include malleable surfaces, such as rubber. The idler roller is configured to contact a sticky surface of liner-less label stock and is thus comprised of silicone rubber. The drive roller and the idler roller cooperatively counter rotate to advance the label stock past the nip at block 412. Next a slackness of the label stock is determined after it exits the nip at block 416. A test is made at block 420 to determine whether slackness of the ribbon is within a preselected range. If so, the process returns to block 408. If slackness is out of range, a test is made at block 424 to determine slackness is below the range, meaning that there is too much slack in the ribbon. If so, the drive roller is sped up at block 428 before the process returns to block 408. If not, the drive roller is slowed down at block 432 before the process returns to block 408.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A liner-less label printer pre-feed system comprising:
an idler roller;
a drive roller having a first contact surface aligned with a second contact surface of the idler roller to form a nip, the nip configured to receive label stock from an associated roll;
a motor configured to rotate the drive roller wherein the drive roller drives a counter rotation of the idler roller so as to move the label stock through the nip and to an associated label printer;
a sensor configured to determine slackness of the label stock when disposed between the nip and a label printer; and
a controller configured to control a speed of the motor to maintain the label stock within a preselected slackness range.

2. The system of claim 1 wherein the sensor is comprised of a non-contact object sensor.

3. The system of claim 2 wherein the sensor is further comprised of a reflective object sensor.

4. The system of claim 1 wherein the first contact surface and the second contact surface are deformable.

5. The system of claim 4 wherein the first contact surface is comprised of rubber and wherein the second contact surface is comprised of silicone rubber.

6. The system of claim 1 wherein the nip is configured to receive the label stock into the nip with an adhesive surface contacting the idler roller.

7. The system of claim 1 wherein the controller is further configured to speed rotation of the drive roller when the slackness is less than a lower threshold level and slow rotation of the drive roller when the slackness is greater than an upper threshold level.

8. A method of feeding a liner-less label printer comprising:
receiving label stock into a nip between a drive roller and an idler roller;
rotating the drive roller to move label stock through the nip cooperatively with the idler roller urged by the drive roller to counter rotate at the nip and feed the label stock to an associated label printer;
determining a slackness of the label stock between the nip and a label printer; and
adjusting a rotation speed of the drive roller in accordance with a determined slackness.

9. The method of claim 8 wherein adjusting the rotation speed of the drive roller comprises:
speeding rotation of the drive roller when the slackness is less than a lower threshold level; and
slowing rotation of the drive roller when the slackness is greater than an upper threshold level.

10. The method of claim 8 wherein the drive roller and the idler roller include a rubber surface.

11. The method of claim 10 further wherein the idler roller surface is further comprised of a silicone surface in contact with an adhesive side of the label stock.

12. The method of claim 8 further comprising determining the slackness in accordance with an output of an object sensor.

13. The method of claim 12 wherein the object sensor is comprised of a reflective object sensor.

14. An inline printer paper feed system comprising:
a first pair of opposed feed rollers configured to cooperatively rotate and remove linear label stock from an associated roll;
a second pair of opposed feed rollers disposed after the first pair of opposed feed rollers and configured to cooperatively rotate to advance the label stock received from the first pair of opposed feed rollers;
a position sensor configured to determine a slackness of label stock between the first pair of opposed feed rollers and the second pair of opposed feed rollers;
a controller configured to selectively control a rotation speed of the first pair of opposed feed rollers in accordance with a determined slackness.

15. The system of claim 14 wherein the label stock includes an adhesive side having an exposed adhesive and a nonadhesive, and wherein the first pair of opposed feed rollers are configured to contact the adhesive side with a surface comprised of silicone rubber.

16. The system of claim 14 wherein the position sensor is comprised of a contactless optical position sensor.

17. The system of claim 16 wherein the contactless optical position sensor is comprised of an array of light emitting diodes and phototransistors.

18. The system of claim 17 wherein the first pair of opposed feed rollers is comprised of a drive roller and an idler roller, and wherein the idler roller is configured to contact the adhesive side.

19. The system of claim 14 wherein the controller is comprised of a microcontroller configured to control one or more motors associated with the drive roller.

20. The system of claim 19 further including a stepper motor operable by the microcontroller to control rotation of the drive roller.

21. The system of claim 20 wherein the microcontroller is further configured to:
slow rotation of the stepper motor when the determined slackness passes a first preselected slackness threshold; and
speed up rotation of the stepper motor when the determined slackness passes a second preselected slackness threshold.

22. The system of claim 19 wherein the position sensor is configured to determine the determined slackness by identifying, from a phototransistor, light reflected from one or more light emitting diodes.
